(19) United States
(12) Patent Application Publication
(10) Pub. No.: US 2008/0109393 A1
(43) Pub. Date: May 8, 2008

(54) Method of sequencing resources of a resource base relative to a user request

(75) Inventors: Alexandre Delteil, Meudon (FR); Mohamed Zied Maala, Saint Denis (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 11/975,424

(22) Filed: Oct. 19, 2007

(30) Foreign Application Priority Data
Oct. 19, 2006 (FR) 06/54386

(51) Int. Cl. G06N 7/00

(52) U.S. Cl. 706/56

(57) ABSTRACT

A method of sequencing resources of a resource base relative to a user request, said resources being grouped together into concepts of a set of concepts using an expressive language such as a description logic, and said request corresponding to a concept of said set, said method using a distance measurement between two concepts, one of said two concepts corresponding to one of said resources and the other of said two concepts corresponding to said request, said distance measurement comprising a step (E1) for determining the least common subsuming concept (LCS) of said two concepts, or the most general subsumed concept (MGS) of said two concepts, wherein said distance measurement also comprises a step (E2) for determining intermediate concepts between said two concepts and said least common subsuming concept (LCS), or between said two concepts and said most general subsumed concept (MGS), from logic constructors of said expressive language.

### RELATED APPLICATIONS

This application claims the priority of French application no. 06/54386 filed Oct. 19, 2006, the content of which is hereby incorporated by reference.

### FIELD OF THE INVENTION

The present invention relates to the fields of information technology and artificial intelligence. More specifically, the invention relates to the distance measurement between two concepts belonging to one and the same set of concepts.

### BACKGROUND OF THE INVENTION

In the present invention, the sets to which the concepts on which distances are measured belong use expressive languages of the description logic type. A description logic is a formal system of representation of knowledge that can be used to describe or annotate instances, such as, for example, a video document base, or a medical knowledge base in a quite different field. This formal system thus makes it possible to:
declare an instance,
declare that an instance belongs to a certain class, called “concept”,
declare which are the relations, called “roles”, that exist between the instances,
declare which are the values of certain properties, for example the fact that the value associated with a relation is an integer, a real number or a character string,
define concepts from other concepts, relations, instances and logic constructors specific to the description logic.

A complex concept defined from other concepts is also called “concept description”. Hereinafter, unless explicitly defined, the term “concept” is used to designate both a complex concept and a basic concept, also called “primitive” concept.

The distance measurement between concepts is used in numerous applications, in the fields of data analysis, the semantic web and the classification of multimedia resources, which are images, videos, audio documents or text documents, for example.

Notably, the notion of distance between two concepts, embodied in a distance measurement, or the notion of proximity between two concepts, embodied in a similarity measurement, can both, indifferently, be used to sequence the resources of a resource base relative to their appropriateness to a user request. This request is in practice very often expressed in the form of a concept description using key words, which are concepts whose instances are resources of the resource base, and logic constructors linking these concepts.

The relations between concepts, which arise from the presence of logic constructors or predefined relations, give a semantic dimension to these measurements of distance or similarity between concepts. Thus, the invention can be used in Internet search engines, on online sales sites, on online help or solution base management software, but also on customer relations software and on information portals.

Similarly, the notions of distance or proximity between concepts are used to automatically classify and group together the resources of a resource base. The aim of classification is to store a new resource in classes defined previously and in which certain resources are already classified. The objective is thus to store a new resource in the class containing the resources that are the most similar to it. As for the grouping together of resources, the aim of this is to create groups of resources such that the similar resources are classified in one and the same group. It also makes it possible to create a hierarchy of groups, and thus to classify the most similar resources in groups at the lowest levels, whereas the least similar resources are classified in groups at the highest levels.

It should be noted that the nature of the sequenced, classified or grouped together resources, whether these resources are images or videos, is immaterial from the moment when the annotations of these resources are made with one and the same expressive language.

Furthermore, while the invention seeks to measure a distance between concepts, the distance measurement according to the invention has a naturally corresponding similarity measurement, which is the inverse of the distance measured according to the invention.

The prior art techniques for measuring between concepts relate more to similarity measurements than to distance measurements. A distinction is drawn between four existing categories of similarity measurements according to the information used to evaluate these measurements:
In a first category, the measurement of similarity between two concepts consists in determining the shortest path between these two concepts, that is, for example, the minimum number of arcs that separates them in a predefined hierarchical structure. Such a measurement is described, for example, in the article by Z. Wu and M. Palmer, entitled “Verb Semantics and Lexical Selection”, published on the occasion of an ACL (Associations for Computational Linguistics) conference in 1994. This measurement requires the concepts whose similarities are measured to be organized within a predefined hierarchy, for example in a concept tree or graph.
In a second category, the information-oriented content of the concepts is used to evaluate a measurement of similarity between two concepts. Thus, in the article by P. Resnik entitled “Using information content to evaluate semantic similarity in a taxonomy”, published on the occasion of an IJCAI (International Joint Conference for Artificial Intelligence) conference in Montreal in 1995, probability data associated with the concepts of one and the same set of concepts is used. This category therefore requires information to be obtained that is specific to each of the concepts of the set that is of interest. For example, the similarity measurement defined by P. Resnik requires the existence of a probability model that can be applied to this set, or the existence of an instance base making it possible to obtain statistical information for each of the concepts of the set.
In a third category, the common and discriminating characteristics between concepts are used, to evaluate a measurement of similarity between two concepts. Such a measurement is defined in the article by A. Tversky, entitled “Features of similarity”, and published in 1977 in the magazine “Psychological Review”. However, this definition is abstract and does not specify how to obtain, in a precise application context or in a particular language, the common and discriminating characteristics of two concepts.
Finally, in a fourth category, the measurement of similarity between two concepts uses the notion of concept extension, that is, the number of instances of a concept in a resource base described using a description logic. One example of such a measurement is described in the article by C. d'Amato, N. Fanizzi and F. Esposito, entitled “A Semantic Similarity Measure for Expressive Description Logics”, and published on the occasion of the CILC (Convegno Italiano di Logica Computazionale) conference in 2005. This category therefore requires an instance base described in a description logic, the similarity between two concepts being evaluated based on the number of instances belonging to these concepts.

The existing similarity measurements therefore all require, to calculate a distance value between two concepts, information additional to the set of concepts to which they belong, such as a predefined hierarchy of concepts, a probability model or a concept instance base. Furthermore, the first three categories of similarity measurements cannot be used on sets of concepts that use an expressive language, because the existence of logic constructors artificially increases these sets by a large number of concepts for which no additional information is available.

### SUMMARY OF THE INVENTION

One object of the present invention is to resolve the drawbacks of the prior art by providing a method of and a device for sequencing resources which uses a distance measurement according to the invention between two concepts, whether they are complex concepts or basic concepts, these two concepts belonging to a predefined set of concepts formalizing a representation of the knowledge. This formal system is, for example, a description logic, a conceptual graph, a modal logic or a relational language.

This and other objects are attained in accordance with one aspect of the present invention directed to a method of sequencing resources of a resource base relative to a user request, said resources being grouped together into concepts of a set of concepts using an expressive language such as a description logic, and said request corresponding to a concept of said set, said method using a distance measurement between two concepts, one of said two concepts corresponding to one of said resources and the other of said two concepts corresponding to said request, said distance measurement comprising a step for determining the least common subsuming concept of said two concepts, or the most general subsumed concept of said two concepts, wherein said distance measurement also comprises a step for determining intermediate concepts between said two concepts and said least common subsuming concept, or between said two concepts and said most general subsumed concept, from logic constructors of said expressive language.

This method has the advantage of not requiring the existence of a predefined hierarchy between concepts to measure a distance between concepts, nor of requiring additional information on the concepts of one and the same set of concepts. In practice, the inventive method uses the logic constructors of the expressive language of the set of concepts concerned, to construct pieces of hierarchical graph that encompass the two concepts between which are distances being measured. These pieces are formed by intermediate concepts constructed from concepts of this set, that is, concept descriptions, and, where appropriate, from pieces of a predefined hierarchy of concepts, if such a hierarchy pre-exists in the set of concepts. The duly constructed pieces of graph then make it possible to measure a distance between these two concepts.

According to a preferred characteristic, when said set does not include a predefined hierarchy between concepts, said distance measurement according to the invention comprises an additional step for calculating a distance between said two concepts by one or other of the formulae:
d(b,c1)=n_{—}arc(b, LCS)+n_{—}arc(c1, LCS)
or
d′(b,c1)=n_{—}arc(b, MGS)+n_{—}arc(c1, MGS)
in which
d(b,c1) and d′(b,c1) designate distances between two concepts b and c1,
LCS designates the least common subsuming concept of the concepts b and c1,
MGS designates the most general subsumed concept of the concepts b and c1,
n_arc(x, y) is an increasing affine function of the number of intermediate concepts determined previously on a string of concepts between two concepts x and y, the relations between the concepts of said string being subsumption relations.

This method of calculating the distance between concepts has the advantage of providing a mathematical distance, that is, one that satisfies:
the axiom of the separation, according to the proposition:
   if x≠y then d(x,y)>0
the axiom of the symmetry, according to the proposition:
   d(x,y)=d(y,x)
the axiom of the triangular inequality, according to the proposition:
   d(x,y)<d(x,z)+d(z,y)

in which d(x,y), d(x,z) and d(z,y) designate the distances calculated according to the invention respectively between two concepts x and y, between two concepts x and z and between two concepts z and y. Thus, the inventive method makes the results consistent from the logic point of view, which is essential for its use by a search engine for example.

Furthermore, this method of calculation makes it possible to classify the concepts in a strict way. In particular, a resource sequencing application that uses the inventive method will check semantic properties: it will assign one and the same value to resources that have the same characteristics relative to the request from a user and it will sequence the results according to their proximity to the request, from nearest to farthest.

According to another preferred characteristic, when said set comprises a predefined hierarchy of concepts, said distance measurement according to the invention comprises an additional step for calculating a distance between said two concepts by one or other of the formulae:
d(b,c1)=min(n_{—}arc(b, LCS))+min(n_{—}arc(c1, LCS))
or
d′(b,c1)=min(n_{—}arc(b, MGS))+min(n_{—}arc(c1, MGS))
in which
d(b,c1) and d′(b,c1) designate distances between two concepts b and c1,
LCS designates the least common subsuming concept of the concepts b and c1,
MGS designates the most general subsumed concept of the concepts b and c1,
min(n_arc(x, y)) is an increasing affine function of the number of intermediate concepts determined previously on the shortest string of concepts between two concepts x and y, said string being part of a lattice of concepts whose bars interlink concepts by subsumption relations.

This method of calculation is suited to the case where a predefined hierarchy already exists in the set of concepts, and, like the preceding calculation method, makes it possible to classify the concepts in a strict way.

According to another preferred characteristic, the step for determining intermediate concepts between said two concepts and said least common subsuming concept comprises steps for:
calculating the generalizing concepts of one of said two concepts
and calculating the conjunctions of said generalizing concepts with said least common subsuming concept.

This way of constructing the intermediate concepts makes it possible to automate the step for determining intermediate concepts, and, consequently, the distance measurement according to the invention in a set of concepts, when the distance measurement option that uses the notion of least common subsuming concept is chosen.

According to another preferred characteristic, the step for determining intermediate concepts between said two concepts and said most general subsumed concept comprises steps for:
calculating the generalizing concepts of one of said two concepts
and calculating the conjunctions of said generalizing concepts with the other of said concepts.

This construction of the intermediate concept between one of the two concepts and their most general subsumed concept also makes it possible to automate the distance measurement according to the invention, when the distance calculation option that uses the notion of most general subsumed concept is chosen.

Another aspect of the invention is directed to a search engine comprising a resource base, said resources being grouped together into concepts of a set of concepts using an expressive language such as a description logic, said engine being suitable for interrogating said resource base from a user request corresponding to a concept of said set, and said engine using the distance measurement according to the invention.

Another aspect of the invention is directed to a system for sequencing resources relative to a user request, using the distance measurement according to the invention.

Another aspect of the invention is directed to a computer program comprising instructions for implementing the inventive method, when run on a computer.

The search engine, the sequencing system and the computer program have advantages similar to those of the inventive method.

### BRIEF DESCRIPTION OF THE DRAWINGS

FIG. 1 represents an example of concepts of a set of concepts relating to video films,

FIG. 2 represents various steps of the distance measurement according to the invention,

FIG. 3 represents an algorithm for constructing intermediate concepts in a first distance measurement option according to the invention,

FIG. 4 represents a part of a lattice of concepts encompassing two concepts between which a distance is measured according to the invention,

FIG. 5 represents an algorithm for constructing intermediate concepts in a second distance measurement option according to the invention,

FIG. 6 represents a system of sequencing resources relative to a user request,

FIG. 7 represents a resource classification system, and

FIG. 8 represents a resource grouping system.

### DETAILED DESCRIPTION OF THE DRAWINGS

According to a preferred embodiment of the invention, distances are, measured between concepts belonging to one and the same set of concepts which uses the “ALE” description logic, a description of which is given in the book by D. Nardi and R. J. Brachman entitled “The Description Logic Handbook” and published by Cambridge University Press. This embodiment is, however, easily adaptable for measuring distance between concepts of sets of concepts using other languages.

The “ALE” description logic is provided with the following logic constructors: “AND” represented by the logic symbol π, “SUCH_THAT_ONE” represented by the logic symbol ∃, “SUCH_THAT_ALL” represented by the logic symbol ∀, and “NO” represented by the logic symbol [symbol] . The constructors used in a particular description logic define the richness and the expressiveness of said logic: a description logic becomes all the more expressive as more constructors are used.

The constructors of the “ALE” language can be used to construct complex concepts, having a precise semantic while remaining fairly intuitive. Similarly, these constructors can be used to define complex relationships, formed by relations and constructors.

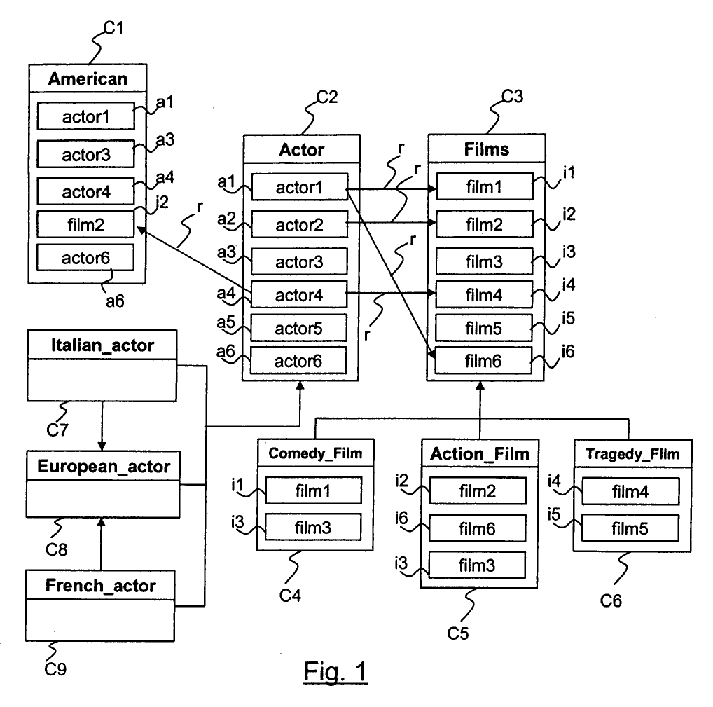

Thus, in the exemplary set of concepts represented in FIG. 1:
The relation r, meaning “actor of”, links the actors of the concept C2 containing all the actors of this set of concepts, to the films in which they have appeared. For example, the instance al corresponding to the actor “actor1” is linked by the relation r to the film instances i1 and i6, which means that this actor has appeared in the corresponding films “film1” and “film6”.
The concept “C4 AND C5” describes the concept containing the set of the instances belonging to both C4 and C5, in this case, the instance i3 corresponding to the film “film3” common to the concept C4 containing the comedy films and to the concept C5 containing the action films.
The concept “SUCH_THAT_ONE (r, C3)” describes the concept containing the set of the instances linked by at least the relation r to an instance of the concept C3 containing all the films of the set of concepts, that is, it describes the concept formed by the instances a1, a2 and a4 corresponding to the actors “actor1”, “actor2” and “actor4”.
The concept “SUCH_THAT_ALL (r, C3)” describes the concept containing the set of instances such that the latter are linked by the relation r only with instances belonging to the concept C3, that is, the concept formed by the instances a1 and a2, since the instance a4 is linked by the relation r to the concept C3 but also to the concept C1 containing the American films and actors.
The concept “NO(C5)” describes the concept containing the set of the instances not belonging to the concept C5, that is, the concept formed by the instance i1 of the concept C4 and the instances i4 and i5 of the concept C6.
The concept “ALL” in the “ALE” language describes the concept which contains the set of the instances of all the concepts, that is, the instances a1, a2, a3, a4, a5, a6 and i1, i2, i3, i4, i5, i6.

Furthermore, the “ALE” language, like all the description logics, is provided with an order relation which can be used to organize the concepts of one and the same set in a hierarchy. This order relation is the subsumption relation: a first concept is said to be subsumed by a second concept, or even the first concept is more specific or less general than the second concept, if all the instances of the first concept are also instances of the second concept.

For example in FIG. 1, the concept C5 containing the action films, the concept C4 containing the comedy films and the concept C6 containing the tragedy films are subsumed by the concept C3 containing all the films of the set of concepts: this is translated by “any action, comedy or tragedy film is a film”. Similarly, the concept C7 containing the Italian actors, and the concept C9 containing the French actors, are subsumed by the concept C8 containing the European actors, which is itself subsumed by the concept C2 containing all the actors of the set of concepts. These pre-existing relations form a predefined hierarchy between the concepts of the set of concepts represented in FIG. 1, which are basic concepts. When there is no predefined hierarchy in a set of concepts, the only relations between concepts are those that arise from the construction of complex concepts.

This subsumption relation is represented by the logic symbol ⊂. Thus, “the concept C5 is subsumed by the concept C3” is expressed:
C5⊂C3

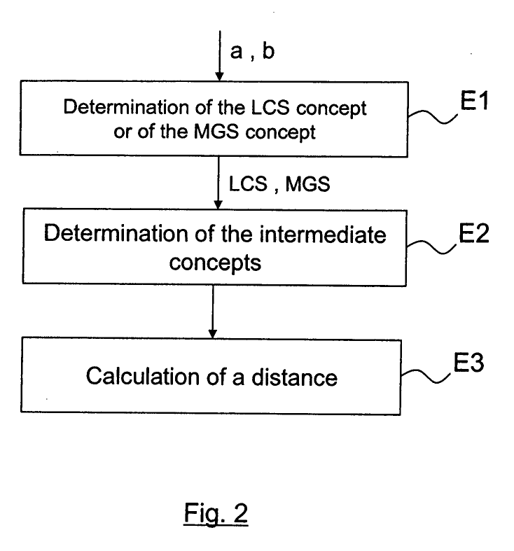

With reference to FIG. 2, the distance measurement between two concepts a and b according to the invention proceeds in three steps E1 to E3. These steps are typically implemented in a computer program. They are, for example, implemented in inference engines such as “RACER”, “FACT” or “PELLET”, designed to reason on description logics.

The first step E1 is the determination of the LCS concept subsuming the least common of the two concepts a and b, or even the determination of the most general subsumed concept MGS of the two concepts a and b, as it is indifferent to use the LCS concept or the MGS concept to measure a distance between the concepts a and b. These two options of the inventive method are presented in turn below.

According to the first option of the inventive method, the least common subsuming concept of the two concepts a and b is determined. The definition of the least common subsuming concept of two concepts, in this case of the concepts a and b, is as follows: the LCS concept is said to be the least common subsuming concept of the concepts a and b if, and only if
a⊂LCS, b⊂LCS and there is no concept x such that, x⊂LCS, a⊂x and b⊂x.

The determination of the LCS concept is performed by using the following formula, given by F. Baader, B. Sertkaya and A. Y. Turhan in their article entitled “Computing the Least Common Subsumer w.r.t. a Background Terminology”, published on the occasion of the “Description Logics” international workshop in 2004:

$${lcs}_{ALE} ( a , b ) = {\prod A}_{A ∈ names ( a ) ⋂ names ( b )} ⊓ {\underline{\prod ⫬ B}}_{⫬ B ∈ names ( a ) ⋂ names ( b )} ⊓ {\prod }_{r ∈ {roles}^{∃} ( a ) ⋂ {roles}^{∃} ( b )} ( {\prod ∃ r , {LCS}_{ALE} ( E , F )}_{E ∈ restrict \begin{matrix}∃ \\ r\end{matrix} ( a ) ⋂ F ∈ restrict \begin{matrix}∃ \\ r\end{matrix} ( b )} ) ⊓ \\ {\prod }_{r ∈ {roles}^{∀} ( a ) ⋂ {roles}^{∀} ( b )} ( {\prod ∃ r , {lcs}_{ALE} ( E , F )}_{E ∈ restrict \begin{matrix}∀ \\ r\end{matrix} ( a ) ⋂ F ∈ restrict \begin{matrix}∀ \\ r\end{matrix} ( b )} )$$

in which
lcs_{ALE}(a,b) is the least common subsuming concept of the two concepts a and b,
names(x) corresponds to the set of concept names that appear in the description of a concept x,
n̅a̅m̅e̅s̅(̅x̅)̅ corresponds to the set of concept names that appear in negative form in the description of a concept x,
roles^{∃}(x) corresponds to the relation names that appear in the constructors “SUCH_THAT_ONE” in the description of a concept x,
roles^{∀}(x) corresponds to the relation names that appear in the constructors “SUCH_THAT_ALL” in the description of a concept x,
restrictᵣ^{∃}(x) represents the set of the concepts appearing in the constructors “SUCH_THAT_ONE” and with the relation r, in the description of a concept x,
and restrictᵣ^{∀}(x) represents the set of the concepts appearing in the constructors “SUCH_THAT_ALL” and with the relation r, in the description of a concept x.

The least common subsuming concept of the two concepts a and b is therefore by this formula defined recursively as being formed by the conjunction:
of the concepts that appear both in the conjunction describing the concept a and in the conjunction describing the concept b,
of the concepts of the form “SUCH_THAT_ONE (r, lcs (E,F))”, in which the concept “SUCH_THAT_ONE (r, E)” appears in the conjunction describing the concept a and the concept “SUCH_THAT_ONE (r, F)” appears in the conjunction describing the concept b,
and of the concepts of the form “SUCH_THAT_ALL (r, lcs (E,F))”, in which the concept “SUCH_THAT_ALL (r, E)” appears in the conjunction describing the concept a and the concept “SUCH_THAT_ALL (r, F)” appears in the conjunction described in the concept b.

It should be noted that even if a predefined hierarchy exists in the set of concepts to which the concepts a and b belong, the LCS concept remains the concept determined by the above formula.

As a variant, if the set of concepts uses a description logic containing the constructor “OR”, the LCS concept is determined by the concept “a OR b” describing the set of resources belonging either to the concept a or to the concept b, whether a predefined hierarchy exists or not in this set of concepts.

According to the second option of the inventive method, the most general subsumed concept MGS of the two concepts a and b is determined. The definition of the most general subsumed concept of two concepts, in this case of the concepts a and b, is as follows: the MGS concept is said to be the most general subsumed concept of the concepts a and b if, and only if
MGS⊂a, MGS⊂b and there is no concept x such that MGS⊂x, x⊂a and x⊂b.

In the description logics, the most general subsumed concept of two concepts a and b is easy to determine and it corresponds to the concept “a AND b”. It should be noted that even if a predefined hierarchy exists in the set of concepts using this description logic, the most general subsumed concept remains the concept “a AND b”.

The next step E2 is the determination of intermediate concepts between the concepts a and b and the LCS concept, or even between the concepts a and b and the MGS concept, according to the option of the inventive method that is to be used to calculate a distance between the concepts a and b.

These intermediate concepts belong to a complete lattice of concepts. This lattice is made up of the basic concepts, and all the possible complex concepts formed from these basic concepts, the constructors and relations of the set of concepts. This lattice has associated with it an order relation which is the subsumption relation. Furthermore, it is complete, which means that each pair of concepts of this lattice has a least common subsuming concept and a most general subsumed concept.

More specifically in this step E2, two concept strings are constructed in this complete lattice, which makes it possible to go respectively from the concept a to the LCS concept and from the concept b to the LCS concept, or even which makes it possible to go respectively from the concept a to the MGS concept and from the concept b to the MGS concept. These two constructions corresponding to the two options of the inventive method are presented in turn below.

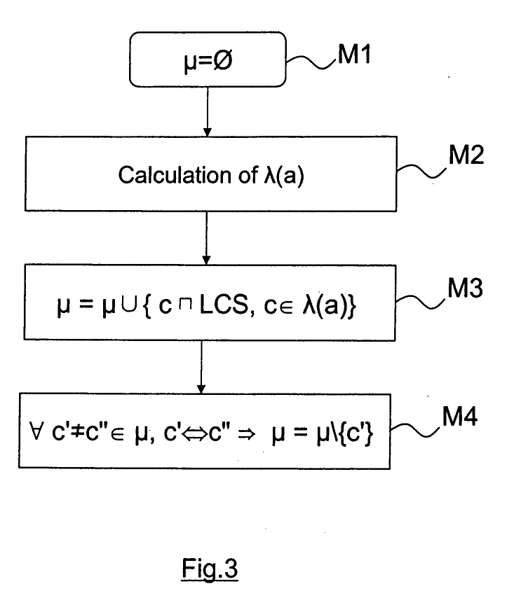

According to the first option of the inventive method, the construction of the set of intermediate concepts between the concept a and the LCS concept in the step E2 is performed automatically by the algorithm represented in FIG. 3, comprising four steps M1 to M4. The construction of the set of intermediate concepts between the concept b and the LCS concept symmetrically uses the same algorithm. This algorithm uses a property of the intermediate concepts between the concepts a and b and the LCS concept which is as follows:
the intermediate concepts between the concept a and the LCS concept are of the form “LCS AND c”, in which c is a concept such that a⊂c,
and the intermediate concepts between the concept b and the LCS concept are of the form “LCS AND c”, in which c is a concept such that b⊂c.

This property makes it possible to construct the intermediate concepts between the concept a and the LCS concept, and between the concept b and the LCS concept, by using the notion of generalizing concept: a concept generalizes another concept if it subsumes the latter.

In a first step M1, the set μ of the intermediate concepts between the concept a and the LCS concept is initialized as being the empty set.

In a second step M2, the set of the generalizing concepts λ(a) of the concept a is calculated. This calculation is done in the “ALE” language as follows:
If the concept a is a primitive concept, the set of the generalizing concepts λ(a) of the concept a contains itself and the concept “ALL”,
if the concept a is of the form “x AND y”, in which x and y are concepts, the set of the generalizing concepts λ(a) of the concept a contains the concepts of the form “u AND v”, in which u is a concept of the set of the generalizing concepts of the concept x, and v is a concept of the set of the generalizing concepts of the concept y,
if the concept a is of the form “SUCH_THAT_ONE (r, x)”, in which r is a relation and x a concept, the set of the generalizing concepts λ(a) of the concept a contains the concepts of the form “SUCH_THAT_ONE (r, y)” in which y is a concept of the set of the generalizing concepts of the concept x,
if the concept a is of the form “SUCH_THAT_ALL (r, x)”, in which r is a relation and x a concept, the set of the generalizing concepts λ(a) of the concept a contains the concepts of the form “SUCH_THAT_ALL (r, y)” in which y is a concept of the set of the generalizing concepts of the concept x.

In a third step M3, for each concept c of the concept λ(a), the concept “c AND LCS” is added to the set μ of the intermediate concepts between the concept a and the LCS concept.

Finally, in a last step M4, the duplicates of the duly constructed set μ of the intermediate concepts are deleted. Thus, for all the concepts c′ and c″ belonging to the set μ, if the concept c′ is equivalent to the concept c″, the concept c′ is deleted from this set μ. In this step M4, the concepts equivalent to the LCS concept and to the concept a are also deleted, in order to keep only intermediate concepts.

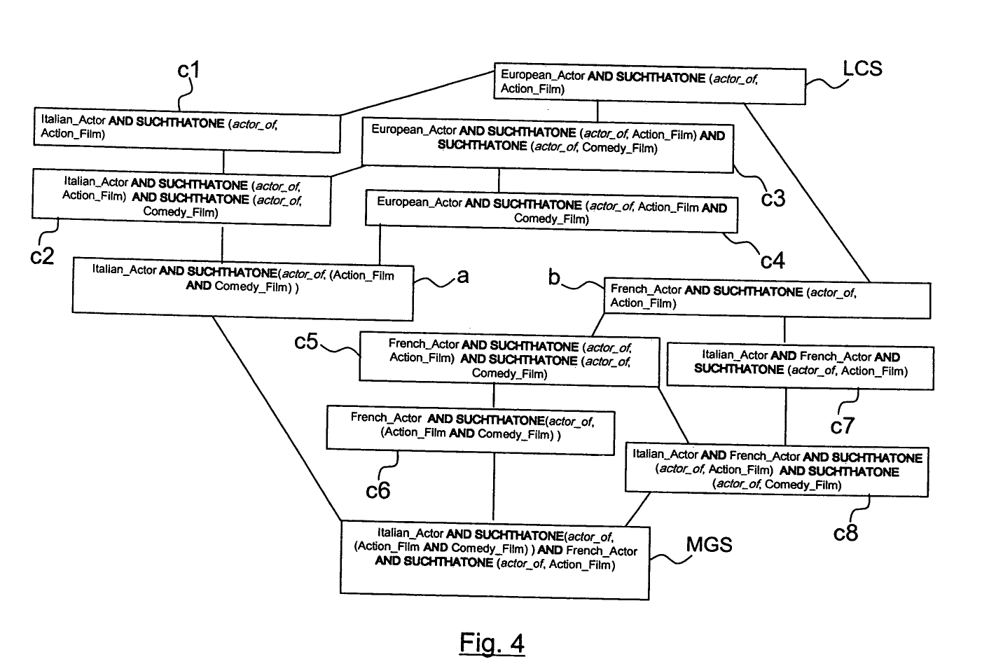

Thus, in the example of FIG. 4, the concept a which contains all the Italian actors having appeared in action films which are also comedy films, which is also expressed “C7 AND SUCHTHATONE(r, (C4 AND C5))”, has, for its generalizing concept:
λ(a)=λ(C7 AND SUCHTHATONE(r,(C4 AND C5)))
={x AND y, xελ(C7), yελ(SUCHTHATONE(r, (C4 AND C5)))}
={x AND y, xε{C7, ALL}, yε{SUCHTHATONE(r, u), uελ(C4 AND C5)}}
={x AND y, xε{C7, ALL}, yε{SUCHTHATONE(r, u), uε{v AND w, vελ(C4), wελ(C5)}}}
={x AND y, xε{C7, ALL}, yε{SUCHTHATONE(r, u), uε{v AND w, vε{C4,ALL}, wελ{C5, ALL}}}}
={x AND y, xε{C7, ALL}, yε{(SUCHTHATONE(r, u), uε{ALL, C4 AND C5, C4, C5}}}
={ALL, SUCHTHATONE(r, C4 AND C5),SUCHTHATONE(r, C4), SUCHTHATONE(r, C5), C7, C7 AND SUCHTHATONE(r, C4 AND C5), C7 AND SUCHTHATONE(r, C4), C7 AND SUCHTHATONE(r, C5)}
in which

λ is the operator generalizing a concept,

and x, y, u, v, w are concepts.

With the LCS concept being the set of the European actors having appeared in action films, which is also expressed “C8 AND SUCHTHATONE(r,C5)”, the set of the intermediate concepts between the concept a and the LCS concept is as follows:

{C8 AND SUCHTHATONE(r,C5) AND c, cελ(a)}={C8 AND SUCHTHATONE(r,C5), C8 AND SUCHTHATONE(r,C4 AND C5), C8 AND SUCHTHATONE(r,C5) AND SUCHTHATONE(r,C4), C8 AND SUCHTHATONE(r,C5), C7 AND SUCHTHATONE(r,C5), C7 AND SUCHTHATONE(r, C4 AND C5), C7 AND SUCHTHATONE(r,C5) AND SUCHTHATONE(r, C4), C7 AND SUCHTHATONE(r, C5)}={LCS, c4, c3, LCS, c1, a, c2, c1)}

It should be noted that the above calculation implicitly uses the equivalence “C7 AND C8 [symbol] C7” due to the predefined subsumption relation:
C7⊂C8

By deleting the concepts equivalent to the LCS concept and to the concept a in the above set of intermediate concepts, four intermediate concepts c1, c2, c3 and c4 are found, which are as follows:
the concept c1 is the set of the Italian actors having appeared in an action film,
the concept c2 is the set of the Italian actors having appeared in an action film and having appeared in a comedy film,
the concept c3 is the set of the European actors having appeared in an action film and having appeared in a comedy film,
and the concept c4 is the set of the European actors having appeared in action films which are also comedy films.

By applying the same method to determine the intermediate concepts between the concept b and the LCS concept, it is found that there are no intermediate concepts between the concept b and the LCS concept.

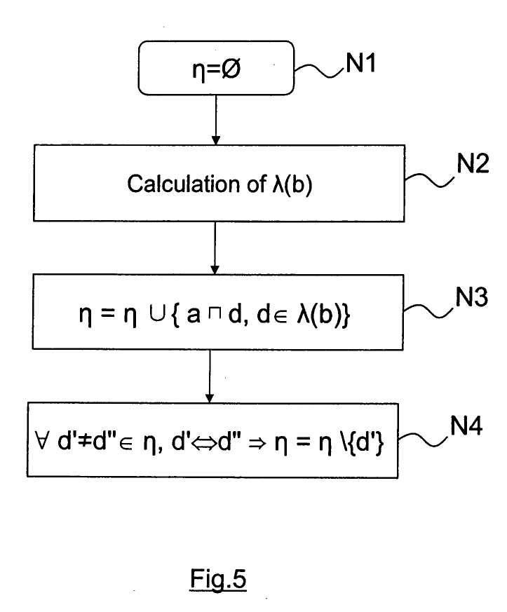

According to the second option of the inventive method, the construction of the set of the intermediate concepts between the concept a and the MGS concept in the step E2 is performed automatically by the algorithm represented in FIG. 5, comprising four steps N1 to N4. The construction of the set of the intermediate concepts between the concept b and the MGS concept symmetrically uses the same algorithm. This algorithm uses a property of the intermediate concepts between the concepts a and b and the MGS concept which is as follows:
the intermediate concepts between the concept a and the MGS concept are of the form “a AND d”, in which d is a concept such that b⊂d,
and the intermediate concepts between the concept b and the MGS concept are of the form “b AND d”, in which d is a concept such that a⊂d.

This property makes it possible to construct the intermediate concepts between the concept a and the MGS concept, and between the concept b and the MGS concept, by using the notion of generalizing concept,

In a first step N1, the set η of the intermediate concepts between the concept a and the MGS concept is initialized as being the empty set.

In a second step N2, the set of the generalizing concepts λ(b) of the concept b is calculated.

In a third step N3, for each concept d of the concept λ(b), the concept “a AND d” is added to the set η of the intermediate concepts between the concept a and the MGS concept.

Finally, in a last step N4, the duplicates of the duly constructed set η of the intermediate concepts is deleted. Thus, for all concepts d′ and d″ belonging to the set η, if the concept d′ is equivalent to the concept d″, the concept d′ is deleted from this set η. In this step N4, the concepts equivalent to the MGS concept and to the concept a are also deleted, in order to keep only the intermediate concepts.

Thus, in the example of FIG. 4, the concept b which contains the set of the French actors having appeared in an action film, which is also expressed “C9 AND SUCHTHATONE(r, C5)”, has, for its generalizing concept:
λ(b)=λ(C9 AND SUCHTHATONE(r, C5))
={x AND y,xελ(C9), yε{SUCHTHATONE(r, u), uελ(C5)}}
={x AND y, xε{C9, ALL}, yε{SUCHTHATONE(r, u), uε{C5, ALL}}}
={C9 AND SUCHTHATONE(r, C5), C9, SUCHTHATONE(r, C5), ALL}
in which
λ is the operator generalizing a concept,
and x, y, u are concepts.

With the concept a being the set of the Italian actors having appeared in action films which are also comedy films, which is also expressed “C7 AND SUCHTHATONE(r, C4 AND C5)”, the set of the intermediate concepts between the concept a and the MGS concept is as follows:
{C7 AND SUCHTHATONE(r, C4 AND C5) AND d, dελ(b)}
={C7 AND C9 AND SUCHTHATONE(r, C4 AND C5), C7 AND C9 AND SUCHTHATONE(r, C4 AND C5), C7 AND SUCHTHATONE(r, C4 AND C5), C7 AND SUCHTHATONE(r, C4 AND C5)}
={MGS, MGS, a, a}

In practice, the MGS concept, which has been calculated in the step E1 as being the concept “a AND b”, or “C7 AND SUCHTHATONE(r, (C4 AND C5)) AND C9 AND SUCHTHATONE(r, C5)”, corresponds to the set of the Italian actors who are also French actors and who have appeared in action films which are also comedy films. The MGS concept is therefore equivalent to the concept “C7 AND C9 AND SUCHTHATONE(r, C4 AND C5)”.

By deleting the concepts equivalent to the MGS concept and to the concept a in this set, it is found that there are no intermediate concepts between the concept a and its MGS.

Similarly, the set of the intermediate concepts between the concept b and the MGS concept is as follows:
{b AND x, xελ(a)}
={C9 AND SUCHTHATONE(r, C5) AND x, xελ(a)}
={C9 AND SUCHTHATONE(r, C5), C9 AND SUCHTHATONE(r, C4 AND C5), C9 AND SUCHTHATONE(r, C5) AND SUCHTHATONE(r, C4), C9 AND SUCHTHATONE(r, C5), C7 AND C9 AND SUCHTHATONE(r, C5), C7 AND C9 AND SUCHTHATONE(r, C4 AND C5), C7 AND C9 AND SUCHTHATONE(r, C5) AND SUCHTHATONE(r, C4), C9 AND C7 AND SUCHTHATONE(r, C5)}
={b, c6, c5, b, c7, MGS, c8, c7}

By deleting the concepts equivalent to the MGS concept and to the concept b in this set, four intermediate concepts are found between the concept b and the MGS concept which are as follows:
the concept c5 is the set of the French actors having appeared in an action film and in a comedy film,
the concept c6 is the set of the French actors having appeared in action films which are also comedy films,
the concept c7 is the set of the Italian actors who are also French actors having appeared in an action film,
and the concept c8 is the set of the Italian actors who are also French actors having appeared in an action film and in a comedy film.

As a variant, if the set of concepts to which the concepts a and b belong uses a description logic containing the constructor “OR”, the same method as previously is used to construct the intermediate concepts, but by limiting the size of the concepts used. In practice, in a description logic that uses the constructor “OR”, the set of the generalizing concepts of a concept is potentially infinite, because it contains all the concepts of the form:
“x OR y”,

in which
x is the concept for which the set of the generalizing concepts is being calculated,
and y is another concept of the set of concepts.

It is therefore necessary in this variant to modify the steps M2 or N2, depending on the option of the inventive method chosen, to take into consideration in the calculated set of generalizing concepts, only the concepts for which the size is less than a predetermined value. The size of a concept is defined, for example, as the number of constructors “OR” appearing in its description plus the value one. The size of the concept “a OR b” is then 2.

Finally, in a step E3 of the distance measurement according to the invention, a distance is calculated between the concept a and the concept b. This calculation differs according to the option chosen, that is, the use of the LCS concept or of the MGS concept, and according to the existence or not of a predefined hierarchy in the set of concepts to which the concepts a and b belong.

The distance between the two concepts a and b is defined, in the distance measurement according to the invention, as the length of a string of intermediate concepts determined in the step E2, that makes it possible to go from the concept a to the concept b passing either via their least common subsuming concept LCS or via their most general subsumed concept MGS. The relations between the concepts of this string are subsumption relations, determined either by the very construction of these concepts, or by a predefined relation between these concepts if a predefined hierarchy exists in the set of concepts. In other words, this string is part of a complete lattice of concepts:
the nodes of this lattice are the basic concepts of the set of concepts and all the possible complex concepts constructed from these basic concepts,
and the bars of this lattice are the subsumption relations arising from the construction of the complex concepts of the lattice, and the predefined subsumption relations if such relations pre-exist in the set of concepts.

In the case where there is no predefined hierarchy in the set of concepts, the length of a string between the concept a and the concept b passing via the LCS concept is always the same, regardless of the intermediate concepts passed through. This length is also equal to that of a string between the concept a and the concept b, passing via the MGS concept.

Thus, in the example of FIG. 4, there are two strings of concepts with which to go from the concept a to the concept b passing via the LCS concept, the strings {a, c2, c1, LCS, b} and {a, c4, c3, LCS, b}, and two strings of concepts with which to go from the concept a to the concept b, passing via the MGS concept, the strings {a, MGS, c6, c5, b} and {a, MGS, c8, c7, b}. These four strings all have the same length.

The distance between the concept a and the concept b is then calculated by one or other of the formulae:
d(a,b)=n_{—}arc(a, LCS)+n_{—}arc(b, LCS)
or
d′(a,b)=n_{—}arc(a, MGS)+n_{—}arc(b, MGS)
in which
d(a,b) and d′(a,b) designate the distances between two concepts a and b,
LCS designates the least common subsuming concept of the concepts a and b,
MGS designates the most general subsumed concept of the concepts a and b,
n_arc(x, y) is the number of concepts on a string of concepts going from the concept x to the concept y, incremented by one unit, in other words, n_arc(x, y) is the number of arcs between the concepts x and y in the complete lattice of concepts described above.

The distance calculated between two concepts by using one or other of these two formulae is the same.

It should be noted that other similar formulae can also be considered, for example by using more generally an increasing affine function of the number of intermediate concepts determined previously on a string of concepts between the concepts a and b, passing either via the LCS concept or via the MGS concept.

Furthermore, if, as a variant, the set of concepts to which the concepts a and b belong uses the constructor “OR”, the lattice of concepts described above is not complete in as much as the number of intermediate concepts has been limited in the step E2 for measuring distance according to the invention. However, the same distance calculation formulae can be used, the only difference being that the string of concepts for which the length is measured is in fact a string of a finite subset of this complete lattice.

In the case where there is a predefined hierarchy in the set of concepts, the strings of concepts between two concepts passing via the least common subsuming concept or the most general subsumed concept of these two concepts are not necessarily of the same length. In practice, a pre-existing subsumption relation can short circuit intermediate concepts determined in the step E2 for measuring distance according to the invention. In this case, the distance between the concepts a and b is calculated by one or other of the formulae:
d(a,b)=min(n_{—}arc(a, LCS))+min(n_{—}arc(b, LCS))
or
d′(a,b)=min(n_{—}arc(a, MGS))+min(n_{—}arc(b, MGS))
in which
d(a,b) and d′(a,b) designate distances between two concepts a and b,
LCS designates the least common subsuming concept of the concepts a and b,
MGS designates the most general subsumed concept of the concepts a and b,
min(n_arc(x, y)) is the number of arcs between the concepts x and y on the shortest string of concepts between these two concepts x and y, in the complete lattice of concepts described above, which takes account of the pre-existing relations of the predefined hierarchy.

With these two formulae giving results that are not necessarily identical, an application using the inventive method on a set of concepts having a predefined hierarchy must always use just one of these two formulae.

As a variant, if the taxonomy to which the concepts a and b belong uses the constructor “OR”, this shorter string is part of a finite subset of the complete lattice of concepts described above, taking into account the pre-existing relations of the predefined hierarchy.

As in the preceding case, other similar formulae can be envisaged, for example using an increasing affine function of the number of intermediate concepts determined previously on the shortest string of concepts between the concepts a and b, passing either via the LCS concept or via the MGS concept.

Furthermore, it should be noted that, in this step E3, the calculation of the distance between the concepts a and b using the MGS concept is the most interesting option when the set of concepts uses the “HALE” language. In practice, the calculation of the distance between the concepts a and b is then much faster using the MGS concept than using the LCS concept. This is due to the fact that the calculation of the least common subsuming concept of two concepts a and b in the “ALE” language is very complex and requires a computation time proportional to
2ⁿ^{ₐ}⁺ⁿ^{_{b}}
in which
nₐ is the number of constructors in the description of the concept a,

and n_{b} is the number of constructors in the description of the concept b, whereas the calculation of the most general subsumed concept of the concepts a and b is done in a single operation.

The distance calculated in this way in the step E3 is a semantic distance which has a meaning in the application comparing distances between concepts.

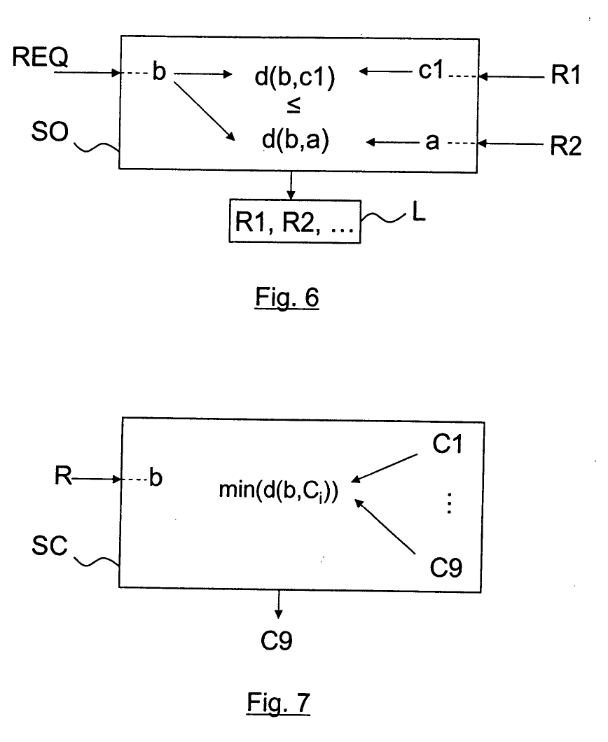

Thus, in the context of a sequencing application implemented in a server SO represented in FIG. 6, using the distance measurement according to the invention, the resources corresponding to the concepts semantically the closest to a request REQ from a user are returned as a priority to that user. For example, if the user request REQ is to search for a French actor having appeared in an action film, which corresponds to the concept b in FIG. 4, the resource RI corresponding to the concept c1 is better classified than the resource R2 corresponding to the concept a in the list L returned to the user. In practice, the distance d(b,a) between the concept a and the concept b calculated according to the step E3 is 4, whereas the distance d(b,c1) between the concept c1 and the concept b calculated according to the step E3 is 2. This means that the user has more chance of finding resources corresponding to his request in the set of the Italian actors having appeared in action films than in the set of the Italian actors having appeared in action films which are also comedy films, which appears intuitively exact.

Similarly, in a classification application implemented in a server SC represented in FIG. 7, using the distance measurement according to the invention, a resource R will be classified in a class of concepts of an existing taxonomy according to its semantic proximity to the classes of this taxonomy. For example, if the resource R corresponds by its description to the concept b, and if the taxonomy comprises nine classes corresponding to the concepts C1 to C9, the classification application calculates the minimum distance min(d(b, Cᵢ)) between the resource R and the classes C1 to C9. Since the minimum distance corresponds to the class C9, the concept b will be classified in the class C9 containing the French actors.

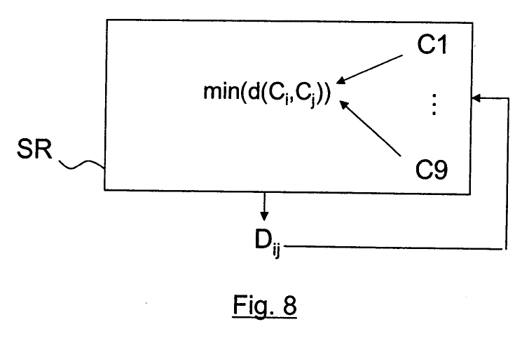

Finally, in a grouping application implemented in a server SR represented in FIG. 8, using the distance measurement according to the invention, resources comparable to concepts are grouped together in higher-level concepts according to a hierarchical tree. For example, if the resources to be grouped together correspond to the concepts C1 to C9, the application calculates the matrix of the distances d(Cᵢ,Cⱼ) between each pair of concepts. Then, the concepts between which distance is the minimum are grouped together in pairs in a higher level of concepts Dᵢⱼ. The distances between the new concepts Dᵢⱼ are then calculated, then the concepts Dᵢⱼ are grouped together in a similar way in a higher level of concepts, and so on, until a root concept is created that subsumes all the concepts C1 to C9.

What is claimed is:

1. A method of sequencing resources of a resource base relative to a user request (REQ), said resources being grouped together into concepts of a set of concepts using an expressive language such as a description logic, and said request (REQ) corresponding to a concept (b) of said set, said method using a distance measurement between two concepts, one of said two concepts (c1) corresponding to one of said resources (R1) and the other of said two concepts (b) corresponding to said request, said distance measurement comprising a step (E1) for determining the least common subsuming concept (LCS) of said two concepts (b,c1), or the most general subsumed concept (MGS) of said two concepts (b,c1),
wherein said distance measurement also comprises a step (E2) for determining intermediate concepts between said two concepts (b,c1) and said least common subsuming concept (LCS), or between said two concepts (b,c1) and said most general subsumed concept (MGS), from logic constructors of said expressive language.

2. The method of sequencing resources of a resource base as claimed in claim 1, wherein said set of concepts does not include a predefined hierarchy between concepts, said method being characterized in that said distance measurement comprises an additional step (E3) for calculating a distance between said two concepts (b,c1) by one or other of the formulae:
d(b,c1)=n_{—}arc(b, LCS)+n_{—}arc(c1, LCS)
or
d′(b,c1)=n_{—}arc(b, MGS)+n_{—}arc(c1, MGS)
in which
d(b,c1) and d′(b,c1) designate distances between two concepts b and c1,
LCS designates the least common subsuming concept of the concepts b and c1,
MGS designates the most general subsumed concept of the concepts b and c1,
n_arc(x, y) is an increasing affine function of the number of intermediate concepts determined previously on a string of concepts between two concepts x and y, the relations between the concepts of said string being subsumption relations.

3. The method of sequencing resources of a resource base as claimed in claim 1, wherein said set of concepts comprises a predefined hierarchy of concepts, said method being characterized in that said distance measurement comprises an additional step (E3) for calculating a distance between said two concepts (b,c1) by one or other of the formulae:
d(b,c1)=min(n_{—}arc(b, LCS))+min(n_{—}arc(c1, LCS))
or
d′(b,c1)=min(n_{—}arc(b, MGS))+min(n_{—}arc(c1, MGS))
in which
d(b,c1) and d′(b,c1) designate distances between two concepts b and c1,
LCS designates the least common subsuming concept of the concepts b and cl,
MGS designates the most general subsumed concept of the concepts b and c1,
min(n_arc(x, y)) is an increasing affine function of the number of intermediate concepts determined previously on the shortest string of concepts between two concepts x and y, said string being part of a lattice of concepts whose bars interlink concepts by subsumption relations.

4. The method of sequencing resources of a resource base as claimed in claim 1, wherein the step (E2) for determining intermediate concepts between said two concepts (b,c1) and said least common subsuming concept (LCS) comprises steps for:
calculating (M2) the generalizing concepts of one of said two concepts and calculating (M3) the conjunctions of said generalizing concepts with said least common subsuming concept (LCS).

5. The method of sequencing resources of a resource base as claimed in claim 1, wherein the step (E2) for determining intermediate concepts between said two concepts (b,c1) and said most general subsumed concept (MGS) comprises steps for:
calculating (N2) the generalizing concepts of one of said two concepts (b,c1)
and calculating (N3) the conjunctions of said generalizing concepts with the other of said two concepts (c1,b).

6. A search engine comprising a resource base, said resources being grouped together into concepts of a set of concepts using an expressive language such as a description logic, said engine being suitable for interrogating said resource base from a user request (REQ) corresponding to a concept (b) of said set, said engine comprising means of measuring distance between two concepts, said measurement means comprising means (E1) of determining the least common subsuming concept (LCS) of said two concepts, or the most general subsumed concept (MGS) of said two concepts,
wherein said measurement means also comprise means (E2) of determining intermediate concepts between said two concepts and said least common subsuming concept (LCS), or between said two concepts and said most general subsumed concept (MGS), from logic constructors of said expressive language.

7. A system for sequencing resources of a resource base relative to a user request (REQ), said resources being grouped together into concepts of a set of concepts using an expressive language such as a description logic, and said request corresponding to a concept of said set, said system comprising means of measuring distance between two concepts, said measurement means comprising means (E1) of determining the least common subsuming concept (LCS) of said two concepts, or the most general subsumed concept (MGS) of said two concepts,
wherein said measurement means also comprise means (E2) of determining intermediate concepts between said two concepts and said least common subsuming concept (LCS), or between said two concepts and said most general subsumed concept (MGS), from logic constructors of said expressive language.

8. A computer program comprising instructions for implementing the method as claimed in claim 1, when run on a computer.
